(19) United States
(12) Patent Application Publication
(10) Pub. No.: US 2026/0120593 A1
(43) Pub. Date: Apr. 30, 2026

(54) DENTAL TRAINING DEVICE

(71) Applicant: ORATOMIC4D PTY LTD, Parramatta, New South Wales (AU)

(72) Inventors: Leif SVENSSON, New South Wales (AU); Vincenzo SORRENTINO, New South Wales (AU)

(21) Appl. No.: 19/145,218

(22) PCT Filed: Aug. 24, 2023
(86) PCT No.: PCT/AU2023/050816

§ 371 Date: Jul. 2, 2025

(30) Foreign Application Priority Data
Jan. 30, 2023 (AU) 2023900206

(51) Int. Cl. G09B 23/28

(52) U.S. Cl. CPC G09B 23/283

(57) ABSTRACT

A dental training device comprised of a base having at least one cavity. A plurality of attachment means extend from the at least one cavity to an artificial tooth located within the at least one cavity. The plurality of attachment means are adapted to break when an application of force is applied to the artificial tooth, allowing for the removal of the artificial tooth from the respective cavity.

### CROSS-REFERENCES TO RELATED APPLICATIONS

This US Non-Provisional Utility patent application claims the benefit of and priority to PCT Application Serial No. PCT/AU2023/050816, filed Aug. 24, 2023, entitled “Dental Training Device,” which claims the benefit of and priority to Australian Patent Application Serial No. 2023900206, filed Jan. 30, 2023, entitled “Dental Training Device,” the entire contents of both applications of which are hereby incorporated herein by reference.

### FIELD OF THE INVENTION

The present invention relates generally to a dental training device and method.

### BACKGROUND

Dental practitioners diagnose and treat a range of hard and soft tissue diseases within the oral cavity, including diseases of the teeth, gums, soft tissues, and other structures of the mouth. In order to provide a high degree of patient care, dental students undertake at least four to five years of university-based training to qualify as dental practitioners, and continue to engage in training and education following graduation.

Presently, dental students and dental practitioners train using dental typodont training models to practise a range of dental procedures that include but are not limited to exodontia, oral surgery, endodontics, restorative dentistry (fillings, crowns, bridges, veneers), periodontal treatment, cosmetic dentistry and implantology.

Plastic dental typodont models have been in continuous use in dentistry for over a century with relatively little change. Typodont models represent an idealised dentition comprised of a uniform set of upper and lower plastic or thermoplastic teeth held in place within a plastic jaw by screws, hot glue or simulated gums made from silicone. Typodont teeth are an approximation of human teeth but do not accurately replicate the natural tooth crown, root or internal anatomy including the supporting structures. For comparison natural human teeth are held into the jaw bone by periodontal ligaments comprised of collagen. The periodontal ligaments are attached to the root surfaces of teeth at one end, and the alveolar bone (socket) at the other, suspending the tooth in the jaw bone. During the removal of a natural tooth, it is necessary to sever the periodontal ligament's bond to the tooth by applying an appropriate rotational or twisting motion with enough force to allow the tooth to be removed.

Unfortunately, typodont teeth that are attached to the plastic gum area or jaw by either silicone, hot glue, or a screw, do not adequately mimic the tactile experience of removing a tooth from a patient, as they do not mimic the severing of the periodontal ligaments.

It would be advantageous if there were provided a dental training model and/or method which considered the bond of the periodontal ligaments, and the related forces required for tooth extraction resulting in a greater tactile experience and more closely simulating the forces required for tooth extraction.

Further, current dental training models are often modelled on a perfect set of teeth with an idealised occlusion (the manner in which the upper and lower teeth fit together in the bite). Understandably, it is highly uncommon for a patient to have perfect teeth, and even less common for two sets of teeth to be exactly the same. It would be advantageous if there were provided a dental training model which was able to biologically mimic a patient's set of teeth, allowing either a student or dental practitioner to further improve their technique and skill before undertaking a procedure on a living patient.

Additionally, present dental training models are often created in two separate parts; the teeth and the gums which may include the rest of the jaw. Due to the limitations of the two part manufacturing process, undercuts cannot be present as to prevent seating of the teeth within the gums and jaw. This results in the root portion of typodont plastic teeth to be entirely straight and/or flattened at the apex which is not found in natural human teeth. These separate parts are then assembled into the gums and jaws using hot glue, screws or passive push fit into simulated silicone gums. Additional resources are required to assemble these models which is time consuming, costly, and physically arduous.

It would be advantageous if there were provided a dental training model and/or method which considered the severing of the periodontal ligaments required for a tooth extraction, providing a greater tactile experience for a dental student, as well as an increased educational experience.

It is an object of the present invention to overcome or ameliorate at least one of the disadvantages of the prior art.

### SUMMARY

In accordance with a first aspect of the invention, there is provided a dental training device comprising: a base having at least one cavity; at least one artificial tooth located at least partially within the at least one cavity; a plurality of attachment means extending from the at least one artificial tooth to the at least one cavity; and wherein the plurality of attachment means are adapted to break with an application of force to the at least one artificial tooth.

In an embodiment, the dental training device is used to simulate the removal of a tooth of a patient.

In an embodiment, the dental training device is 3D printed.

In an embodiment, the dental training device further comprises a channel extending from the at least one cavity through the base to a first face of the base.

In an embodiment, the dental training device is unitarily formed.

In an embodiment, the dental training device is formed of resin or plastic.

In an embodiment, the base is adapted to be secured to a support structure.

In an embodiment, a first dental training device and a second dental training device are secured to the support structure to imitate a top and bottom set of teeth.

In an embodiment, the support structure is adapted to be received by a facial manakin of a patient.

In an embodiment, the at least one artificial tooth is comprised of a crown and a root portion.

In an embodiment, the plurality of attachment means extend from the root portion of the at least one artificial tooth to the at least one cavity.

In an embodiment, the at least one artificial tooth further comprises a central chamber filled with a liquid.

In a second aspect of the invention, there is provided a method for simulating drilling into a tooth using the device, comprising: drilling the crown of the at least one artificial tooth towards the central chamber, creating a tooth canal; and liquid escaping from the central chamber through the tooth canal.

In a third embodiment of the invention, there is provided a method for simulating the removal of a tooth using a device, comprising: applying a pulling force to the at least one artificial tooth using one or more tools until the plurality of attachment means break such that the at least one artificial tooth is removed from the at least one cavity.

In a fourth embodiment of the invention there is provided a method for simulating the removal of a tooth using a device, comprising: applying a twisting force to the at least one artificial tooth using one or more tools until the plurality of attachment means break such that the at least one artificial tooth is removed from the at least one cavity.

In fifth embodiment of the invention there is provided a method for simulating the removal of a tooth using a device, comprising: obtaining a scan of a patient's jaw such that their dental cavity information is known; 3D printing a dental training model using the dental cavity information; and applying a force to the at least one artificial tooth of the dental training model to remove the at least one artificial tooth from the at least one cavity.

### BRIEF DESCRIPTION OF THE DRAWINGS

Embodiments of the present invention will now be described, by way of example only, with reference to the accompanying drawings, in which:

FIG. 1 is a top perspective view of a device in accordance with an embodiment of the invention;

FIG. 2 is a front view of the device of FIG. 1 secured to a support structure;

FIG. 3 is a cross sectional view of an embodiment of a device;

FIG. 4 is a front perspective view of an artificial tooth; and

FIG. 5 is a block diagram describing the method used with an embodiment of the device.

### DETAILED DESCRIPTION

Embodiments of the invention described herein relate to a dental training device comprised of a base having at least one cavity. A plurality of attachment means extend from the at least one cavity to an artificial tooth located at least partially within the at least one cavity. The plurality of attachment means are adapted to break when an application of force is applied to the artificial tooth, allowing for the removal of the artificial tooth from the respective cavity.

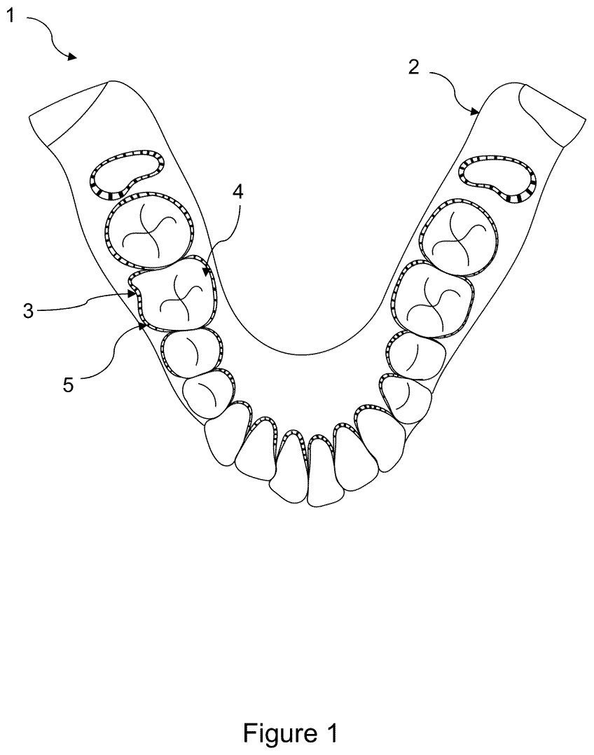

FIG. 1 is a top perspective view of an embodiment of the invention modelling a lower set of teeth of a patient. In particular, a dental training device (1) comprising a base (2) having a number of cavities (3) is illustrated. An artificial tooth (4) is located within each of the respective cavities (3) by way of a plurality of attachment means (5) extending from the respective artificial tooth (4) to the cavity (3) in which the tooth is situated. The plurality of attachment means (5) are adapted to break when an application of force is applied to the artificial tooth (4) they extend from, such that they mimic the periodontal ligaments and their bonded attachment to a tooth in a living patient. The force applied may be a pulling, pushing or twisting force, as per the force a dental practitioner would apply when removing a tooth from a patient, allowing the dental training device (1) to simulate the removal of a tooth in a living patient.

The dental training device (1) is 3D printed as one unitary device made from the same material, being resin. As such, the attachment means are formed of resin which allows for them to be breakable when a force is applied to the artificial tooth they extend from.

By way of example, an embodiment of a method for removing a tooth using the dental training device (1) as in FIG. 1 is described. Firstly, a dental student or practitioner locates the artificial tooth (4) that requires extraction. The dental student or practitioner then applies a pulling, pushing or twisting force to the at least one artificial tooth (4) using one or more tools, until the plurality of attachment means (5) break, such that the at least one artificial tooth (4) is removed from the at least one cavity (3).

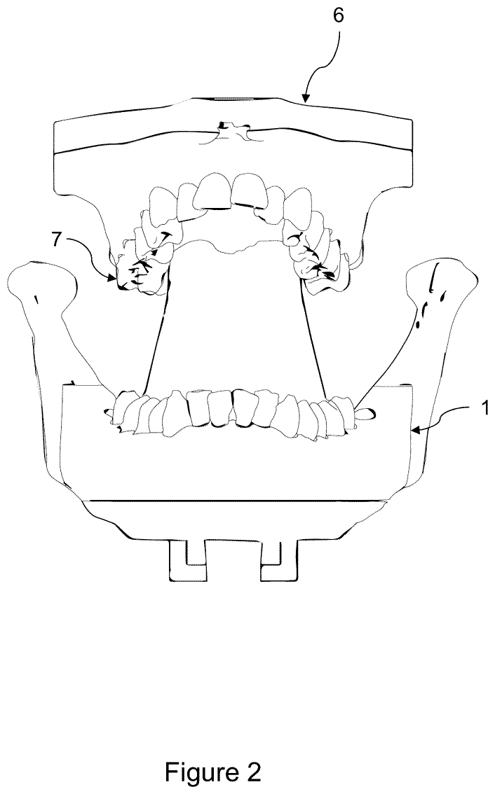

FIG. 2 is a front view of an embodiment of the invention wherein the dental training device (1) of FIG. 1 is secured to a support structure (6). A second dental training device (7) is also secured to the support structure (6) such that the dental training device (1) and second dental training device (7) imitate a top and bottom set of teeth of a patient. The dental training devices (1, 7) are secured to the support structure (6) by way of magnetic fasteners locatable on the base of the dental training devices (1, 7) and the top and bottom portion of the support structure (6). In alternate embodiments, the dental training devices (1, 7) may also be secured to the support structure (6) by way of fasteners, clasps and screws. A person skilled in the art would appreciate the support structure (6) may also only have a single dental training device secured in the event the dental practitioner or student is only practicing on one dental training device, and does not wish to simulate both a top and bottom set of teeth. In an embodiment of the invention, the support structure (6) is adapted to be received by a facial manakin of a patient. The facial manakin may be a standard manakin, or may be a manakin which resembles the patient the artificial teeth were modelled from. The manakin is created by the overlaying of patient intra oral surface scans, CBCT 3D X-ray data as well as patient 3D and 2D facial scans.

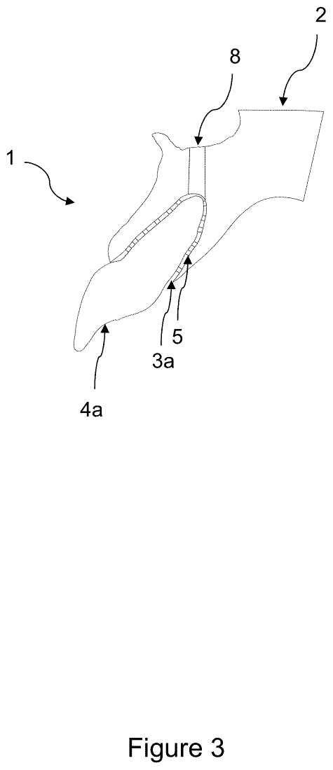

FIG. 3 is a cross section of an embodiment of the dental training device (1) in accordance with an embodiment of the invention further comprising a channel (8). The cross section depicts the base (2) and a cavity (3a). An artificial tooth (4a) is located within the cavity (3a) by way of a plurality of attachment means (5) extending from the respective artificial tooth (4a) to the cavity (3a) in which the tooth is situated. In use, the plurality of attachment means (5) are adapted to break when an application of force is applied to the artificial tooth (4a), such that they mimic the periodontal ligaments and their attachment to a tooth. The force applied may be a pulling, pushing or twisting force, as per the force a dental practitioner would apply when removing a tooth from a patient. The dental device (1) further comprises a channel (8) extending from the cavity (3a) through the base (2) to a first face (9) of the base. Respectively, the dental training device (1) may comprise more than one channel (8), such that a respective channel extends from each cavity (3) of the dental training device (1). As the dental training device (1) is created by 3D printing the device (1) as a unitary product formed of the same material, the channel (8) allows for excess material (i.e. resin, such as UV polymethylmethyl acrylate 3D printable resin) to drain from the cavity (3a), allowing for the attachment means to remain as the only attachment between the artificial tooth (4a) and the base (2).

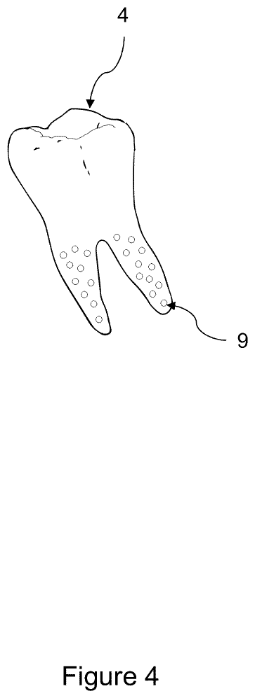

FIG. 4 is a front perspective view of an artificial tooth (4) which has been removed from the dental training device (1) of FIG. 1. In particular, the artificial tooth (4) is comprised of both a crown portion, which when located within the base (2) is predominantly exposed, and a root portion, which when located within the base (2) is predominantly not exposed. As illustrated, a plurality of indentations (9) are located on the root portion of the artificial tooth (4). The plurality of indentations (9) are from the attachment means (5) and illustrate where the attachment means (5) extended from on the artificial tooth (4). In use, a force is applied to the crown portion of the artificial tooth (4) when the artificial tooth is located in the base (2). This force causes the attachment means (5) extending from the root portion of the artificial tooth (4) to break, allowing the artificial tooth (4) to be removed from the base (2), and leaving small indentations (9) or remnants in the artificial tooth (4). In an embodiment, the artificial tooth (4) may further comprise a central chamber filled with a liquid, such as water, or water with red dye, to imitate blood. In use, if the dental student or practitioner requires training which requires drilling into a tooth, they are able to drill into the crown of the tooth such that if they drill too far, they create a tooth canal between the crown top face and chamber, and liquid will escape from the chamber via the tooth canal. This indicates to the dental student that they have drilled too far into the artificial tooth.

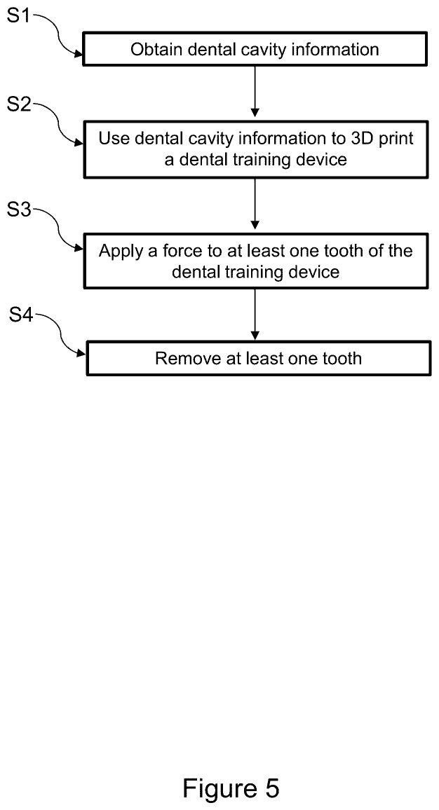

By way of example only, FIG. 5 is a block diagram of a method in accordance with an embodiment of the invention for creating the dental training device (1) of FIG. 1. The method comprises the steps of firstly obtaining a scan of a patient's jaw such that their dental cavity information is known (S1). This scan may be an MRI scan, CT scan, intraoral scanner scan, etc or any scan that provides dental cavity information which can be used to create a 3D printed model of at least part of a patient's jaw. Secondly, the dental cavity information is used to 3D print a dental training model such that the dental training model simulates the position and shape of the one or more teeth of the patient obtained from the scan (S2). The dental training model may be printed on any 3D printing machine or the like. 3D printing allows for the dental training device to be printed as one unitary product. When 3D printing the central training device, the channels extending from the tooth allow excess resin to be drained throughout the curing process, as well as in the post processing step in the fabrication of the device. In an embodiment, these channels follow the angulation of the tooth root tip back to the base of the device. Once printed, the dental training model can be used to train dental students to remove a tooth by applying a force to the at least one artificial tooth of the dental training model (S3) to remove the at least one artificial tooth from the at least one cavity (S4).

The dental training device (1) may be formed of any material that does not depart from the nature of the invention, including resin such as UV polymethylmethyl acrylate 3D printable resin 7,7,9 (or 7,9,9) trimethyl-4, 13-dioxo3,14-dioxa-5,12diazahexadecane-1,16divl bismethacrylate, Tetrahydrofurfuryl methacrylate, Diphenyl(2,4,6trimethylbenzoyl) phosphine oxide (i.e UV polymethylmethyl acrylate 3D printable resin, thermoplastics and injection moulded foam.

A person skilled in the art would appreciate that the base may have at least one cavity, or may have one or more cavities. As such, the base may replicate an entire gum or jaw area, or only part of a gum or jaw area.

There may be any number of attachment means (5) such that there are at least enough attachment means to support the artificial tooth (4) resting within a respective cavity (3). In an embodiment of the invention, the attachment means (5) extend from the at least one artificial tooth (4) such that they follow the contour of the at least one artificial tooth (4), having an angulation between 85 and 95 degrees. The attachment means following the contour of the tooth mimics how the periodontal ligaments follow the contour of a tooth in a patient. The angle of between 85 and 95 degrees further enables enhanced mimicry of the periodontal ligaments in a patient. Alternate angles may be used depending on the size and shape of the base, and are not restricted to between 85 and 95 degrees.

The dental training device may imitate a bottom or top row of teeth. The set of teeth may imitate a living patient, such that the dental training device is created using oral cavity data from the patient. In an alternate embodiment, the dental training device may be created without using oral cavity data from a patient.

In this specification, the word “comprising” is to be understood in its “open” sense, that is, in the sense of “including”, and thus not limited to its “closed” sense, that is the sense of “consisting only of”. A corresponding meaning is to be attributed to the corresponding words “comprise”, “comprised” and “comprises” where they appear.

The preceding description is provided in relation to several embodiments which may share common characteristics and features. It is to be understood that one or more features of any one embodiment may be combinable with one or more features of the other embodiments. In addition, any single feature or combination of features in any of the embodiments may constitute additional embodiments.

In addition, the foregoing describes only some embodiments of the inventions, and alterations, modifications, additions and/or changes can be made thereto without departing from the scope and spirit of the disclosed embodiments, the embodiments being illustrative and not restrictive.

Furthermore, the inventions have described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the inventions. Also, the various embodiments described above may be implemented in conjunction with other embodiments, e.g., aspects of one embodiment may be combined with aspects of another embodiment to realize yet other embodiments.

Further, each independent feature or component of any given assembly may constitute an additional embodiment.

1. A dental training device comprising:
a base having at least one cavity;
at least one artificial tooth located at least partially within the at least one cavity;
a plurality of attachment means extending from the at least one artificial tooth to the at least one cavity; and
wherein the plurality of attachment means are adapted to break with an application of force to the at least one artificial tooth.

2. The device as in claim 1, wherein the dental training device is used to simulate the removal of a tooth of a patient.

3. The device as in claim 1, wherein the dental training device is 3D printed.

4. The device as in claim 1, further comprising:
a channel extending from the at least one cavity through the base to a first face of the base.

5. The device of claim 1, wherein the dental training device is unitarily formed.

6. The device of claim 1, wherein the dental training device is formed of resin or plastic.

7. The device as in claim 1, wherein the base is adapted to be secured to a support structure.

8. The device as in claim 7, wherein a first dental training device and a second dental training device are secured to the support structure to imitate a top and bottom set of teeth.

9. The device as in claim 7, wherein the support structure is adapted to be received by a facial manakin of a patient.

10. The device of claim 1, wherein the at least one artificial tooth is comprised of a crown and a root portion.

11. The device as in claim 10, wherein the plurality of attachment means extend from the root portion of the at least one artificial tooth to the at least one cavity.

12. The device as in claim 10, wherein the at least one artificial tooth further comprises a central chamber filled with a liquid.

13. A method for simulating drilling into a tooth using the device as in claim 12, comprising:
drilling the crown of the at least one artificial tooth towards the central chamber, creating a tooth canal; and
liquid escaping from the central chamber through the tooth canal.

14. A method for simulating the removal of a tooth, comprising:
applying a pulling or twisting force to the at least one artificial tooth using one or more tools until a plurality of attachment means break such that the at least one artificial tooth is removed from the at least one cavity associated with a base,
wherein the plurality of attachment means extend from at least one artificial tooth to the at least one cavity.

15. (canceled)

16. A method for simulating the removal of a tooth, comprising:
obtaining a scan of a patient's jaw such that their dental cavity information is known;
3D printing a dental training model using dental cavity information associated with the scan of the patient's jaw wherein the 3D printed dental training model includes at least (i) a base having at least one cavity (ii) at least one artificial tooth located at least partially within the at least one cavity, (iii) a plurality of attachment means extending from the at least one artificial tooth to the at least one cavity, wherein the plurality of attachment means are adapted to break with an application of force to the at least one artificial tooth; and
applying a force to the at least one artificial tooth of the dental training model to remove the at least one artificial tooth from the at least one cavity.
